(19) United States
(12) Patent Application Publication
(10) Pub. No.: US 2006/0180602 A1
(43) Pub. Date: Aug. 17, 2006

(54) Removal configuration

(76) Inventor: Gunther Hertel, Nurnberg (DE)

Correspondence Address: LERNER GREENBERG STEMER LLP, P O BOX 2480, HOLLYWOOD, FL, 33022-2480, US

(21) Appl. No.: 11/193,092

(22) Filed: Jul. 29, 2005

(30) Foreign Application Priority Data
Dec. 9, 2004 (DE) 10 2004 059 568.2
Jan. 31, 2005 (DE) 10 2005 004 466.2

(51) Int. Cl. B65G 59/00

(52) U.S. Cl. 221/263

(57) ABSTRACT

A configuration for the removal, piece by piece, of stored products has an outwardly totally closed storage area, a removal area that is accessible from the outside, a passage connecting the storage area and the removal area, and a manipulator. The manipulator brings individual products from the storage area through the passage into the removal area.

### BACKGROUND OF THE INVENTION

### Field of the Invention

The present invention relates to a removal configuration for the removal, piece by piece, of products that ate stored in a container.

A problem encountered with self-service in the retail grocery trade, for example, is that fresh products such as fruit, vegetables, bread, cakes and pastries or confectionery goods, are presented to the customers in a fresh and unpacked state on self-service shelves or self-service displays. In order to prevent the product from becoming contaminated by the air breathed or other droplets expelled by the customers, the prior art principle of protecting the fresh products was based on a glass cover or storing them in box containers, which are only opened for removal of the product. It may well be that contamination by breath or other droplet transmission is prevented in this way. The possibility cannot be excluded, however, of a customer touching a fresh product or removing it from the product display and putting it back later. It is undesirable for reasons of hygiene, however, for a subsequent customer to purchase a product that another customer has already touched.

To solve this problem, the principle is previously disclosed of pre-packing the fresh products in small packs and selling these small packs in wrapped form. The product then no longer exhibits the typical characteristics of a fresh product, however, but is perceived by the customer as a pre-packed, conserved, non-fresh product. Furthermore, the customer is also committed to the particular size of pack.

### SUMMARY OF THE INVENTION

It is accordingly an object of the invention to provide a removal configuration which overcomes the above-mentioned disadvantages of the prior art devices of this general type, in which individual products can be removed piece by piece in each case, but without contact taking place before their removal and, at the same time, in such a way that the possibility of putting back a product is prevented once it has been removed.

With the foregoing and other objects in view there is provided, in accordance with the invention, a configuration for removing, piece by piece, stored products. The configuration contains an outwardly totally closed storage area, a removal area accessible from outside, a passage connecting the storage area to the removal area, and a manipulator for bringing individual products from the storage area through the passage and into the removal area.

The configuration in accordance with the invention exhibits an outwardly totally closed storage area. In this context, the expression totally closed does not mean encapsulated in a totally airtight fashion. On the contrary, the storage area is executed as a rule in such a way that one or more access openings are provided to enable it to be refilled with fresh products and, for example, to enable the manipulator belonging to the invention to be introduced into the storage area from the outside and to enable it to be used. Ventilation openings may also be provided for the exchange of air. The aim of the completely closed nature of the storage area in the sense of the invention is to prevent contact from outside with the product stored therein and to prevent products from being put back once they have been removed from the storage area.

In accordance with the invention, removal is effected, in actual fact, by an additional removal area provided in accordance with the invention that is accessible from the outside. The removal area is connected to the storage area via a passage in such a way that individual products can be brought by the manipulator from the storage area into the removal area and then removed individually from the removal area.

It is appropriate in this context to adapt the size of the removal area to suit the products to be stored and removed in such a way that only one of the products fits inside the removal area at any time, with the consequence that only one of the products can be removed from the removal area at any one time. The same applies to the dimensioning of the passage.

In a first embodiment according to the invention, a swiveling flap is provided in the removal area as a device providing access to the removal area. The inner surface of the swiveling flap functions at the same time as a supporting surface for the product to be removed. Therefore, the swiveling flap and the removal area are largely congruent in this embodiment.

It is particularly advantageous to construct the removal area as a removal compartment. The removal compartment can be disposed advantageously adjacent to the storage area, which is itself executed as a very much larger storage compartment. The storage area is surrounded as a general rule by a transparent wall, for example by a Plexiglas cover and Plexiglas side walls. One side wall of the removal compartment separates the removal compartment from the storage area and from the storage compartment. The separating wall is perforated by a transcurrent opening to form the passage. Removal of the individual products is then effected by utilizing the manipulator to cause the individual products to slide from the storage compartment through the passage and into the removal compartment. The removal compartment, which is preferably equipped with the removal flap, is opened by raising the removal flap, and the individual product is removed.

In order to prevent a customer from simply holding the removal flap in its open position when removing the product, in order to enable him/her to examine the product by taking hold of it, and, if it is not satisfactory, from simply putting it back in the storage compartment through the transcurrent opening, a partition is provided that is kinematically connected to the swiveling flap. With the swiveling flap open, the partition closes the transcurrent opening at least partially, so that it is no longer possible, with the swiveling flap open, to put the product back, once it has been removed, through the passage and into the storage area or into the storage compartment. A partition is appropriately securely mounted on the swiveling flap. A guide attached to the swiveling flap is provided for this purpose. The guide is preferably—although not necessarily—oriented at right angles to the swiveling flap. A dual function can advantageously also be assigned to the guide. In addition to the bearing function for the partition, the guide can also serve at the same time as an arrester for the swiveling flap in its open position. The open position also corresponds to the removal position for the product to be removed.

A configuration of the swiveling flap, in which two flap surfaces stand more or less at right angles to one another and as such form two flap wings, is particularly advantageous. One flap wing in this case forms the supporting surface for the product to be removed, while the other flap wing serves as a covering surface for the opening of the removal area. In this embodiment, with the swiveling flap folded up, only the space that is opened up between the two flap wings is accessible to the customer. The actual removal area, on the other hand, is thus not accessible at all to the customer. For this reason, it is also possible to dispense with the partition in this embodiment.

The illustrated embodiment is thus ideally suited to the removal of products, which are only intended to be removed individually or in small numbers on each occasion.

The invention further relates to a second illustrative embodiment, which is itself also suitable to enable the products stored in the storage area to be removed individually and piece by piece. The second embodiment certainly favors the rapid removal of a large number of individual products.

In the second embodiment, the removal area is left open towards the bottom. Because of the “bottomless” configuration of the removal area, the individual product only requires to be displaced from the storage area into the removal area, when it will then drop from the removal area. In order to remove a large number of individual products, it is then only necessary to place or hold a receiving bowl or a receiving container underneath the removal area. It is then possible to transfer a large number of individual products from the storage area via the removal area and into the container relatively quickly by using the manipulator.

It is appropriate in this context to provide attachment elements, for example in the form of clips, tongs, or the like, for a receiving container in the removal area. A suitable receiving container, for example a box or a bag, can then be attached to the removal area so as to leave the hands free to fill the receiving container.

Specifically for the purpose of filling bags or other receiving containers that are not dimensionally stable, it is advantageous to execute the removal area in the form of a chute or a discharge tube. This has the advantage that the chute-shaped configuration of the removal area acts at the same time as a guide for the products to be removed.

It is also advantageous to provide a barrier plate in the floor area of the removal area to act as a device for preventing reaching in. The barrier plate functions in the manner of a check valve. The barrier plate opens, when a product to be removed then falls through, and immediately recloses the removal area after the removal process is complete. This measure also serves the purpose of effectively preventing a manipulation, in particular in the form of putting back the product once it has been removed.

In order effectively to prevent the products from being replaced, it is proposed in a further embodiment of the invention practically to automate the swiveling back of the swiveling flap in the first described embodiment and the swiveling back of the barrier plate in the second described embodiment. This purpose is achieved by configuring both flaps in such a way as to swivel simply against the spring pressure of a spring element, for example a helical spring, in conjunction with opening, that is to say in conjunction with removal, and then to be returned by the spring element to their initial position, in each case the closed position.

In order to be able to offer several types of products in a sales display, the configuration of not just one, but several storage areas next to one another, is envisaged in a further development of the invention. In the case of products of more or less identical size, the opportunity then presents itself of removing the products from two neighboring storage areas via a common removal area. For this purpose, two preferably mutually opposing partition walls are perforated by passages. Products from one of the two storage areas can then be removed in each case through one of the two passages.

A paddle-shaped manipulator is advantageous and simple in terms of its configuration. The manipulator has for this purpose a handle piece projecting from the configuration. The paddle bar of the manipulator penetrates the front side of the configuration in a specially adapted opening. The paddle blade provided in the storage area, disposed opposite the gripping eye on the paddle bar, is used for the manipulation of the products to be removed. The products that have been placed in the storage area can be displaced easily into the removal area with the help of the paddle blade. The paddle-like manipulator is used in this case to displace the individual products in the same way that a rake of a croupier rake is used to displace the chips on the gaming table in a casino.

It is particularly advantageous to support the manipulator in a transverse slot on the front side of the configuration in such a way that it is capable of transverse displacement. The transverse slot in this case serves the dual function as an access for the paddle bar on the one hand, and as a guide path in the transverse direction for the paddle bar on the other hand.

It is advantageous in the first embodiment for the transverse slot to penetrate the front side of the configuration only in the storage area, in order to avoid the possibility of collision between the swiveling flap and the transverse slot. In the case of the embodiment with a removal area that is open towards the bottom, on the other hand, the transverse slot can extend over the whole of the front width of the configuration.

In order to bring about the automatic sliding of the products in the storage area in the direction of the removal area, the floor surface of the storage area is advantageously inclined downwards towards the front side.

To permit refilling of the storage area with fresh product, the storage area can exhibit either a hinged side wall or a hinged rear wall. In the event that the rear wall or the side wall is not accessible, it is advantageous to execute the floor of the storage area or the floor and the front area of the storage area in the form of a drawer. For the purpose of refilling with fresh product, the drawer-like configuration then only needs to be pulled open from the front of the configuration in order to expose the storage space for refilling. It goes without saying that security devices can be provided, which effectively prevent opening of the storage area by unauthorized persons, and in particular by customers.

Other features which are considered as characteristic for the invention are set forth in the appended claims.

Although the invention is illustrated and described herein as embodied in a removal configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, front view of a first embodiment of a swiveling flap according to the invention;

FIG. 2 is a plan view of the embodiment in accordance with FIG. 1;

FIG. 3 is a side view of the embodiment represented in FIG. 1 with the swiveling flap closed;

FIG. 4 is a side view with the swiveling flap opened;

FIG. 5 is a side view with the swiveling flap closed, but with product in place;

FIG. 6 is a side view with the swiveling flap opened, but with product in place;

FIG. 7 is a side view of a preferred embodiment of the swiveling flap;

FIG. 8 is a side view illustrating two functional positions of the swiveling flap illustrated in FIG. 7;

FIG. 9 is a side view of the swiveling flap with a partition executed as an eccentric flap;

FIG. 10 is a diagrammatic, perspective view of the illustrative embodiment represented in FIG. 1 before removal of the product;

FIG. 11 is a perspective view during displacement of the product from the storage area into the removal area;

FIG. 12 is a perspective view of the configuration represented in FIG. 11 with product lying completely in the removal area;

FIG. 13 is a perspective view of the configuration represented in FIG. 12 with the swiveling flap open at the time of removing the product;

FIG. 14 is a diagrammatic, front view of a second embodiment of the invention with a removal area open towards the bottom;

FIG. 15 is a top view of the illustrative embodiment represented in FIG. 14;

FIG. 16 is a side view of the illustrative embodiment represented in FIG. 14 with a receiving bag pushed onto the removal area before filling with product;

FIG. 17 is a side view in accordance with FIG. 16 filled with product;

FIG. 18 is an illustration of a receiving bag;

FIG. 19 is a perspective view of the illustrative embodiment represented in FIG. 14 before removing the product;

FIG. 20 is a perspective view of the second embodiment in accordance with FIG. 19 with product in the removal area and with a receiving bag pushed into place;

FIG. 21 is a perspective view of the removal of a first piece of product in the embodiment in accordance with FIG. 19 and FIG. 20;

FIG. 22 is a perspective view of the illustrative embodiment represented in FIGS. 19 to 21 after removal of the total desired quantity of product; and

FIG. 23 is a perspective view of a third embodiment of the invention with a removal area open towards the front and towards the bottom.

### DESCRIPTION OF THE PREFERRED EMBODIMENTS

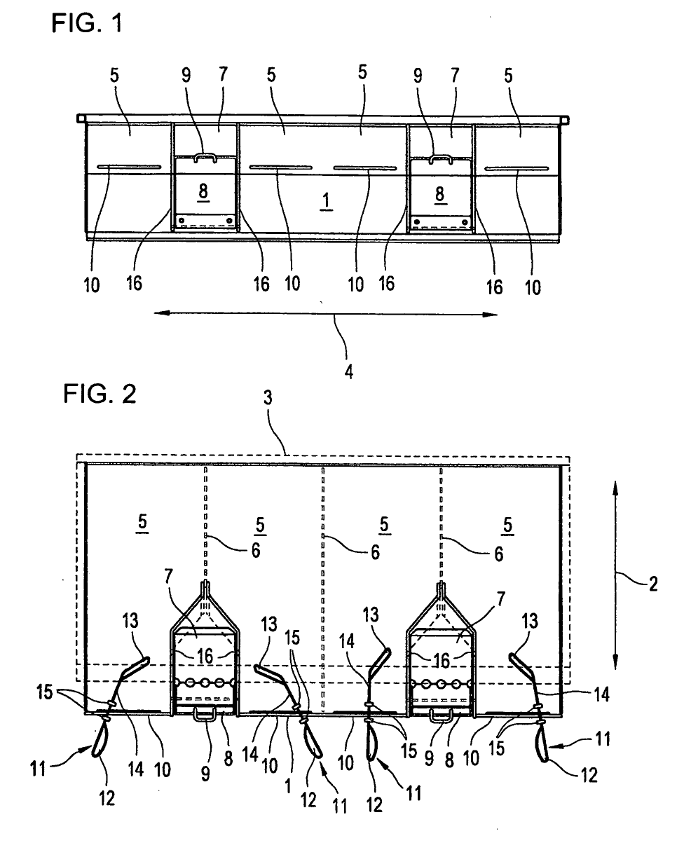

Referring now to the figures of the drawing in detail and first, particularly, to FIGS. 1 and 2 thereof, there is shown a removal configuration in accordance with the invention which has a front side 1 facing towards the customer. Facing away from the front side 1 in a longitudinal direction 2 is a rear side 3. Four storage areas 5 executed as storage compartments are disposed next to one another in a transverse direction 4 running perpendicular to the longitudinal direction 2 in all the illustrative embodiments of the invention. The storage areas 5 are separated from one another in the transverse direction 4 in each case by the storage area partition walls 6. The storage areas 5 in the illustrative embodiment are disposed in pairs in such a way that, in each case, two neighboring storage areas 5 share a common removal area 7. In the illustrative embodiment represented in FIG. 1 and FIG. 2, each removal area 7 is terminated externally towards the front side 1 by the outer surface of a swiveling flap 8. Formed on the swiveling flap 8 is a handle-shaped flap grip 9. In addition, transverse slots 10 are formed in the front side 1. Lying in each of the transverse slots 10 is a manipulator 11 executed in the form of a paddle. Each of the manipulators 11 is capable of being displaced in the transverse slots 10 in the transverse direction 4.

Each manipulator 11 exhibits a gripping eye 12 lying outside the configuration and a paddle blade 13 enclosed inside each storage area 5. The paddle blade 13 and the gripping eye 12 are applied in each case to the end side of a paddle bar 14 connecting them together. Every manipulator 11 together with the paddle bar 14 thus penetrates the front side 1 of the configuration through the associated transverse slot 10 in each case. The manipulators 11 are capable of being displaced along the transverse slots 10 in the transverse direction 4. The ability of the manipulators to be displaced longitudinally in the longitudinal direction 2 is restricted in each case by an arrester rubber 15, which is attached to the paddle bar 14 to both sides of the transverse slot 10. This restriction of the ability of the manipulators 11 to be displaced longitudinally is intended, on the one hand, to prevent the manipulators 11 from being inserted too far into the storage area 5 in the longitudinal direction 2 and, on the other hand, to prevent the manipulator 11 from being pulled too far out of the configuration. The consequence of pulling the manipulator out too far would be that the manipulator 11 in each case would project into the aisles of shelving in front of the configurations. The projection into the aisles is in turn associated with the risk that passing customers may collide with the manipulator 11 and bend it. Unintentional collision with a manipulator 11 could also result in the unintentional removal of product from the configuration.

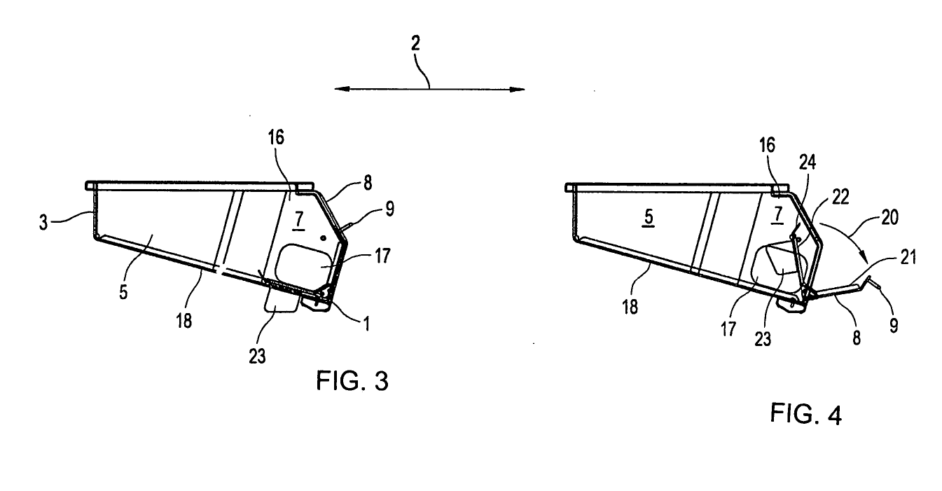

FIG. 3 shows the side view of the removal area 7, more accurately of a partition wall 16 separating the removal area 7 from the neighboring, associated storage area 5. The partition wall 16 is perforated by a transcurrent opening forming a passage 17 of the configuration. In the representation in FIG. 3, furthermore, it can be clearly appreciated that a floor surface 18 of the storage areas 5 connecting the front side 1 and the rear side 3 of the configuration is inclined downwards in each case from the rear side 3 in the direction of the front side 1. The downward inclination from the rear side 3 to the front side 1 in the longitudinal direction 2 accordingly ensures that the products 19 enclosed in the storage area 5 always slide in the direction of the front 1 and thus in the direction of the removal area 7 of the configuration.

The swiveling flap 8 is closed in FIG. 3, whereas FIG. 4 shows the swiveling flap 8 swiveled in the direction of swiveling 20 and opened. It is clear from FIG. 4 in particular that the swiveling flap 8 is executed with two wings. The wing that forms the actual swiveling flap in this case exhibits an inner surface 21 that acts as the supporting surface for the product 19 to be removed. The second wing acts as a guide 22. The guide 22 carries on the one hand a partition 23, and on the other hand an arrester boss 24, which makes contact with the case of the configuration with the swiveling flap 8 open.

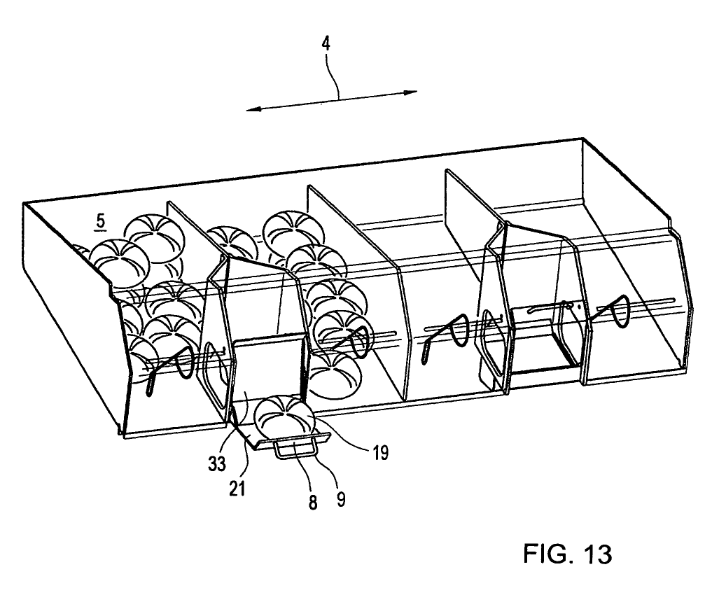

Finally, as a consequence of its plate-shaped execution, the guide 22 performs the additional function of a covering surface 33 for the removal compartment. It can, in fact, be seen clearly in the representation in FIG. 13 that the guide 22 exhibiting the covering surface, with the swiveling flap 8 open, fully closes off the removal area 7 from the outside world.

The partition 23 in turn closes the passage 17 in the transverse direction 4 with the swiveling flap 8 open. The possibility of putting a removed product 19 back in the storage area 5 through the passage 17, with the swiveling flap open, is effectively excluded in this way. It can also be clearly appreciated from FIG. 4 that all that is necessary for this purpose is for the partition 23 to cover and obstruct only part of the area of the passage 17.

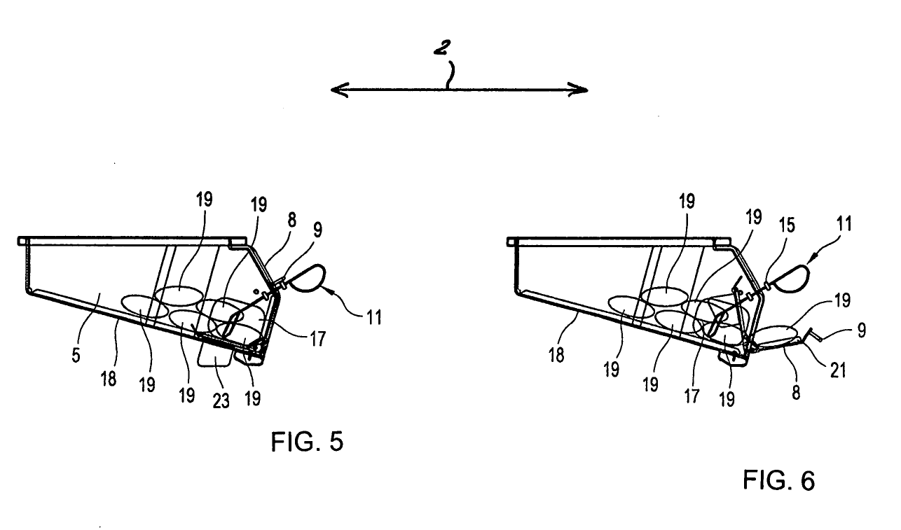

The function of the removal configuration is clearly visible with reference to FIG. 5 and FIG. 6. With the help of the manipulator 11, the product 19 to be removed in each case is caused to slide through the passage 17 and into the removal area 7. The swiveling flap 8 is then opened. The product 19 to be removed then lies on the inner surface 21 of the swiveling flap 8 and can be removed from the swiveling flap 8. The replacement of the product 19 in the storage area 5 is prevented on the one hand by a covering surface 34 formed by the guide 22, which closes the removal area 7 with the swiveling flap 8 open. On the other hand, the partition 23 also ensures that none of the products 19 is capable of being pushed through the passage 17.

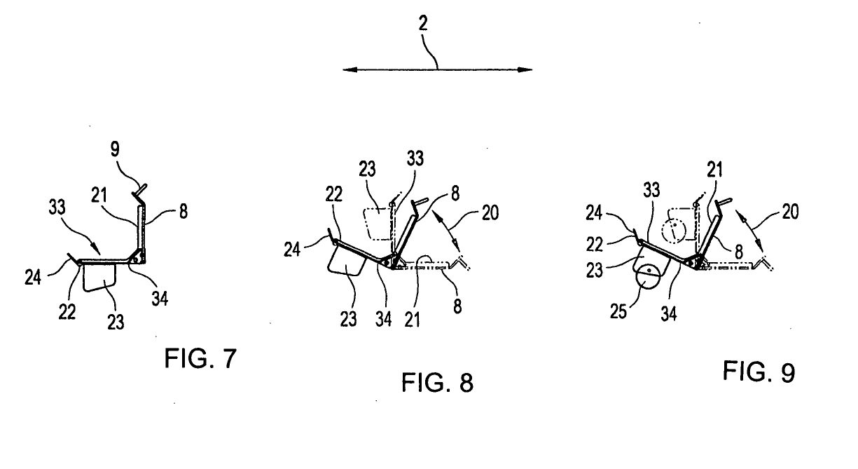

FIG. 7 once again shows the detail of the swiveling flap 8 in the closed position. Very clearly visible here, with the swiveling flap 8 closed, is the vertically standing inner surface 21, which at the same time serves as a supporting surface for the product 19 to be removed. Also visible, furthermore, is the covering surface 33 formed by the guide 22, which covering surface 33 closes off the removal area 7 with the swiveling flap 8 fully open. Also visible, furthermore, is the holding surface 34 facing away from the covering surface 33, to which the partition 23 is adapted. The covering surface 33 and the holding surface 34 thus constitute the two external surfaces of the cover plate which extends at right angles to the swiveling flap 8 in the illustrative embodiment.

FIG. 8 shows the swiveling flap 8 in an initially slightly opened position, and the swiveling flap opened completely in the direction of swiveling 20.

FIG. 9, on the other hand, shows an interesting detail. A moving eccentric plate 25 is formed here on the partition 23. The eccentric plate 25 is caused to swivel, with the swiveling flap 8 closed, into a covering position with the partition 23 and as such occupies no additional swiveling space. The space required beneath the floor surface 18 for the partition 23 in its resting position can be minimized in this way. With the swiveling flap 8 open, the eccentric plate 25 thus maximizes the barrier effect of the partition 23 in relation to the passage 17 and requires a smaller parking space than an enlarged partition 23 with the swiveling flap 8 closed.

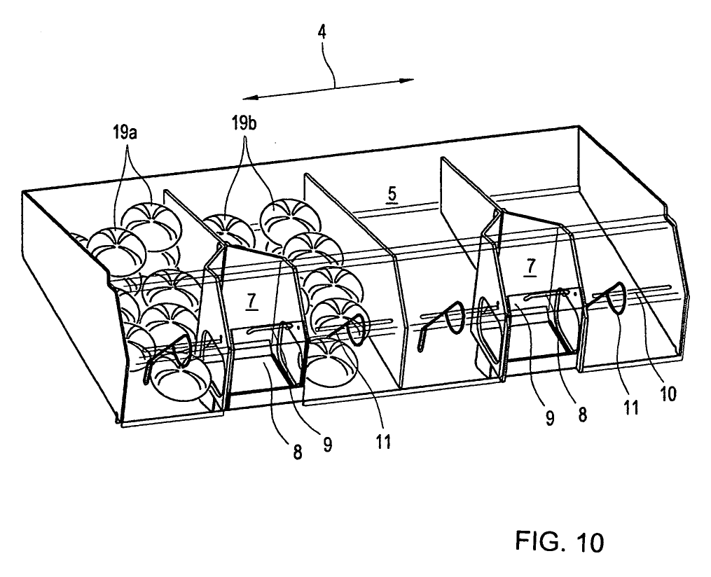

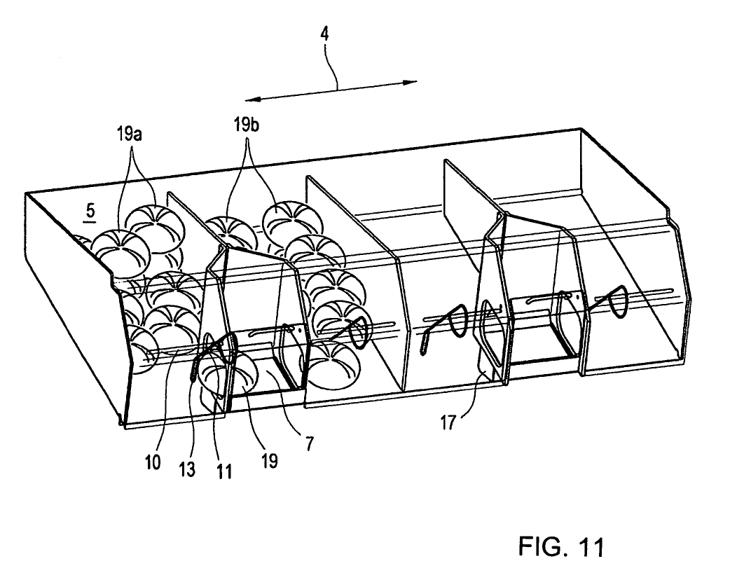

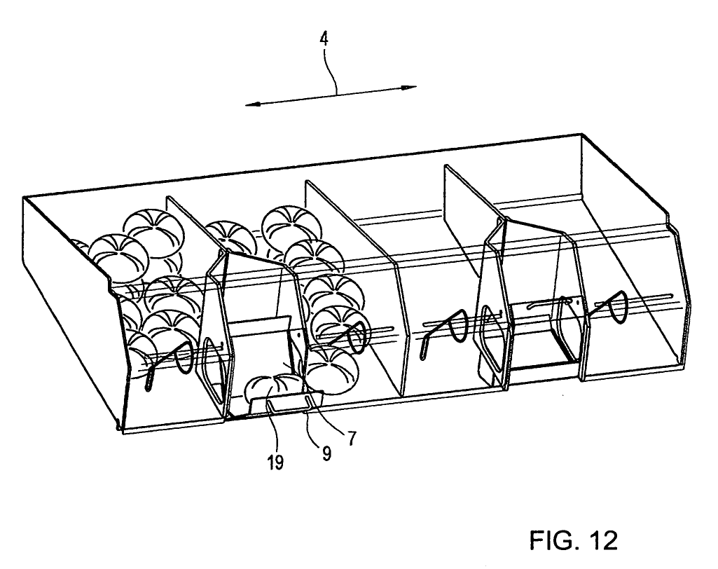

With reference to the representations in FIGS. 10 to 13, the function of the illustrative embodiment of the invention with a swiveling flap 8 may be explained briefly once again at this point. FIG. 10 shows the four storage areas 5 lying adjacent to one another in the transverse direction 4. Products 19 of the different types 19a and 19b—two types of bread roll in the illustrative embodiment—have been inserted in both of the storage areas 5 shown on the left in FIG. 10. In order to remove a product of type 19a from the left-hand storage area 5 in the transverse direction 4, the manipulator 11 assigned to the left-hand storage area 5 is displaced fully to the right in the transverse slot 10, so that the manipulator 11 is able to push the product 19 with the paddle blade 13 from the storage area 5 through the passage 17 and into the removal area 7 in the transverse direction 4 (FIG. 11). As soon as the product 19—as represented in FIG. 12—is present in its entirety in the removal area 7, a start can be made on opening the swiveling flap 8. For this purpose, the operator takes hold of the swiveling flap 8 by the flap grip 9 and causes it to swivel upwards in the direction of swiveling 20. FIG. 13 shows the swiveling flap 8 swiveled fully upwards with the product 19 lying on the inner surface 21 of the swiveling flap 8. In this position, the guide 22 executed as a cover plate obstructs the removal area 7 with its covering surface 33—as already explained—and in this way prevents undesired replacement of the product 19 in the storage area 5.

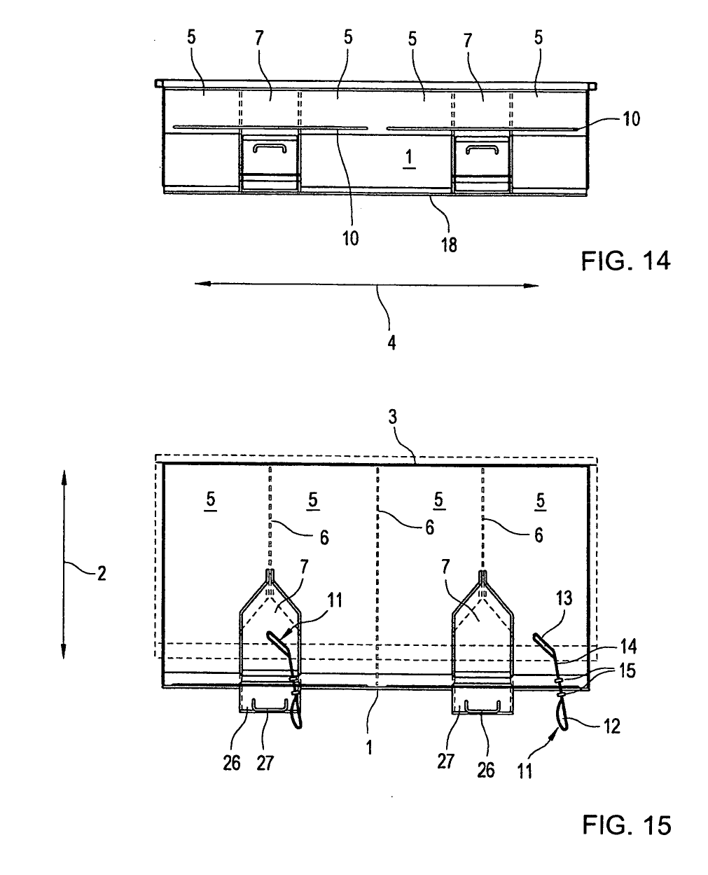

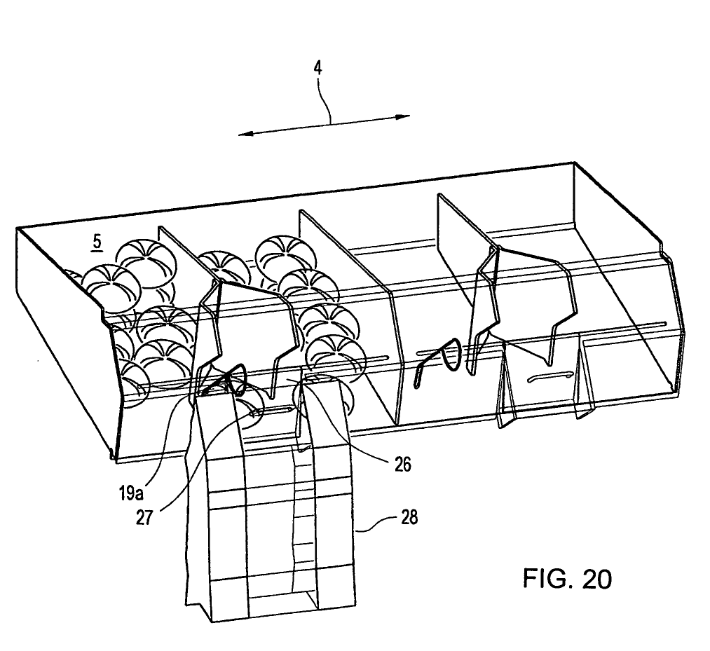

In the second illustrative embodiment described in FIGS. 14 to 22, the component parts that are identical with those in the first illustrative embodiment are provided with identical reference designations. The first priority is then to deal with the differences between the illustrative embodiments. Unless indicated otherwise, the embodiment in accordance with FIGS. 14 to 22 is identical with the embodiment in accordance with FIGS. 1 to 13. Specific attention should be drawn at this point to the fact that mixed forms of both embodiments are, of course, conceivable. It is conceivable, therefore, to provide both of the left-hand storage areas 5 of an configuration in accordance with FIG. 2 and FIG. 15, for example, with a removal area which corresponds to the illustrative embodiment in FIGS. 1 to 13, whereas the removal area 7 assigned to the two other storage areas 5 corresponds to the illustrative embodiment in accordance with FIGS. 14 to 22.

The illustrative embodiment shown in FIGS. 14 to 22 shows a transverse slot 10 extending over the removal area 7 in a transverse direction 4. The manipulators 11 are thus capable of being displaced transversely in the transverse direction 4 along the transverse slot 10 over both of the storage areas 5 assigned to the removal area 7 in each case. The removal areas 7 project forwards—as can be appreciated from FIG. 15—in the longitudinal direction 2 via the front side 1 to form removal chutes 26 which face downwards and are open. Each removal chute 26 carries a retaining hoop 27 on its side wall facing the operator. A receiving container 28 executed as a removal bag in the illustrative embodiment is capable of being attached to the retaining hoop 27. In the case of the baglike receiving container 28 in accordance with the illustrative embodiment, the retaining hoop 27 engages through a retaining slot 29 stamped in the receiving container 28 executed in the form of a bag (FIG. 18). The receiving container 28 executed in the form of a bag in accordance with FIG. 18 has two paper areas 30 on its sides and a central area in the middle executed as a film 31.

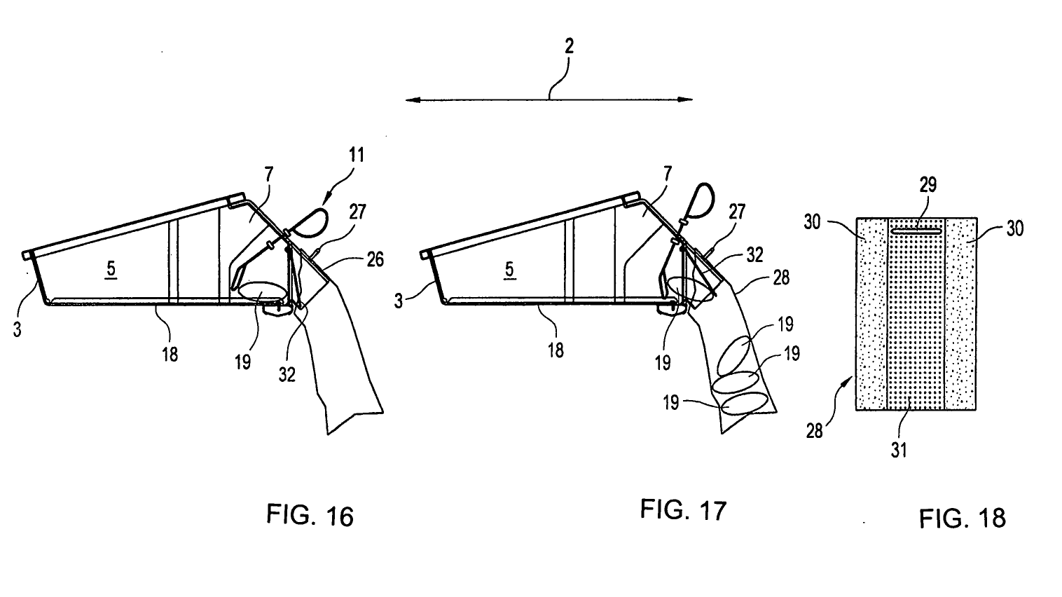

For the purpose of removing the products 19, a product 19 is pushed in each case into the removal area 7 of the configuration with the help of the manipulator 11. Because the removal chute 26 is left open towards the bottom, the product 19 drops by the effect of gravity into the receiving container 28 attached to the retaining hoop 27. Finally, a swiveling barrier plate 32 acting as a device for preventing reaching in can be appreciated from FIGS. 16 and 17. The barrier plate 32 is preferably capable of swiveling against a spring element and in so doing closes automatically after the product 19 has fallen into the receiving container 28.

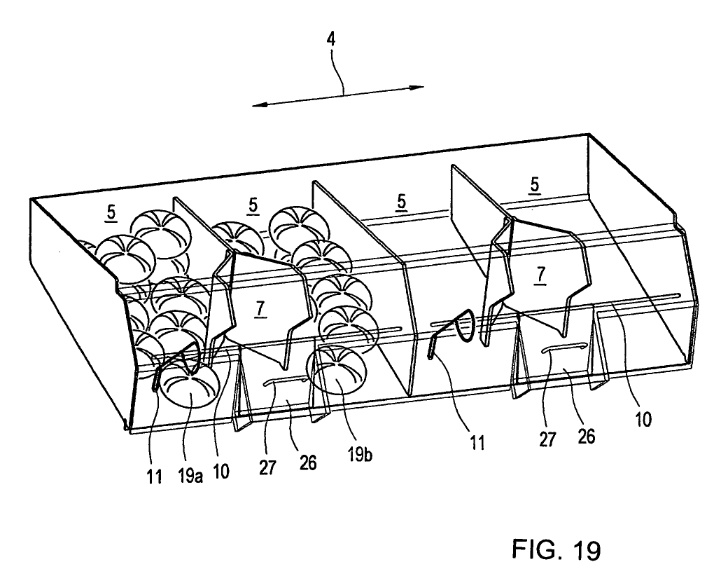

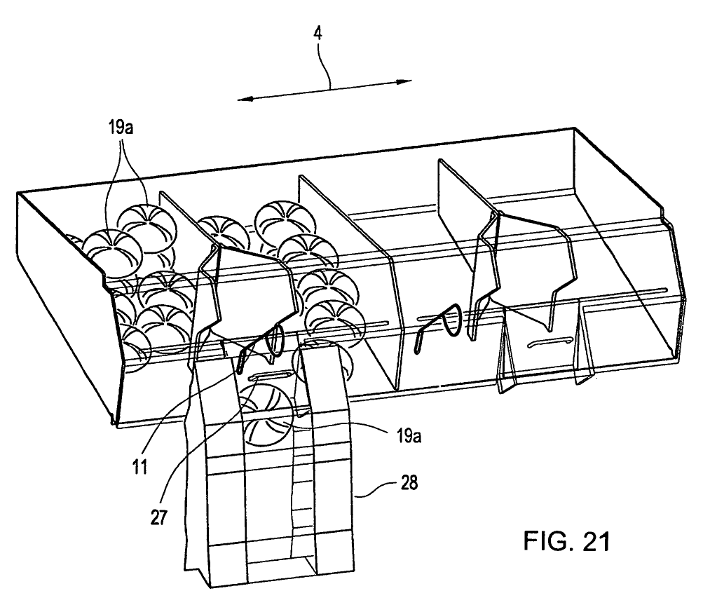

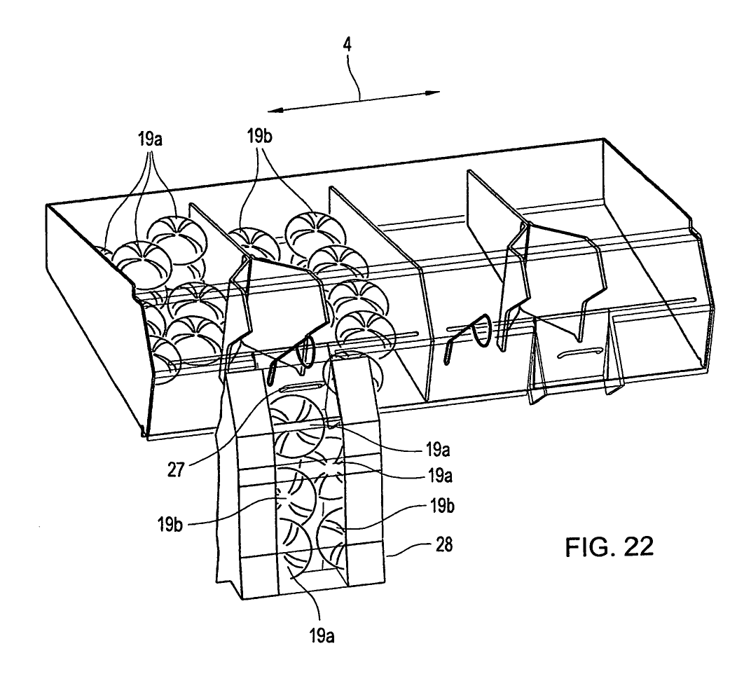

FIG. 19, on the other hand, shows a configuration with four storage areas 5 disposed next to one another in the transverse direction 4. Different types of product 19a and 19b are stored in each case in both of the storage areas 5 shown on the left in FIG. 19. It is also noticeable, furthermore, that the two left-hand storage areas 5 and the two right-hand storage areas 5 in FIG. 19 in each case exhibit only a common transverse slot 10 and also only a common manipulator 11. In order to remove a product 19a, represented here once again as a bread roll, the manipulator 11 assigned to the two left-hand storage areas 5 is displaced in such a way that it causes the product 19a to move in the transverse direction 4 from the storage area 5 through the passage 17 and into the removal area 7. As soon as the product 19a is present in the intended removal area 7, it drops through the removal chute 26 into the receiving container 28 executed as a paper bag. The receiving container 28 is secured to the retaining hoop 27 formed on the removal chute 26 for the removal procedure. As soon as the product 19a, as represented in FIG. 21, drops into the receiving container 28 executed as a bag, further products 19a can be brought into the removal area 7 very rapidly by moving the manipulator 11 back and forth in the transverse direction 4, in order to fill the receiving container 28 executed as a bag, as shown in FIG. 22, with a large number of products of types 19a and 19b as preferred.

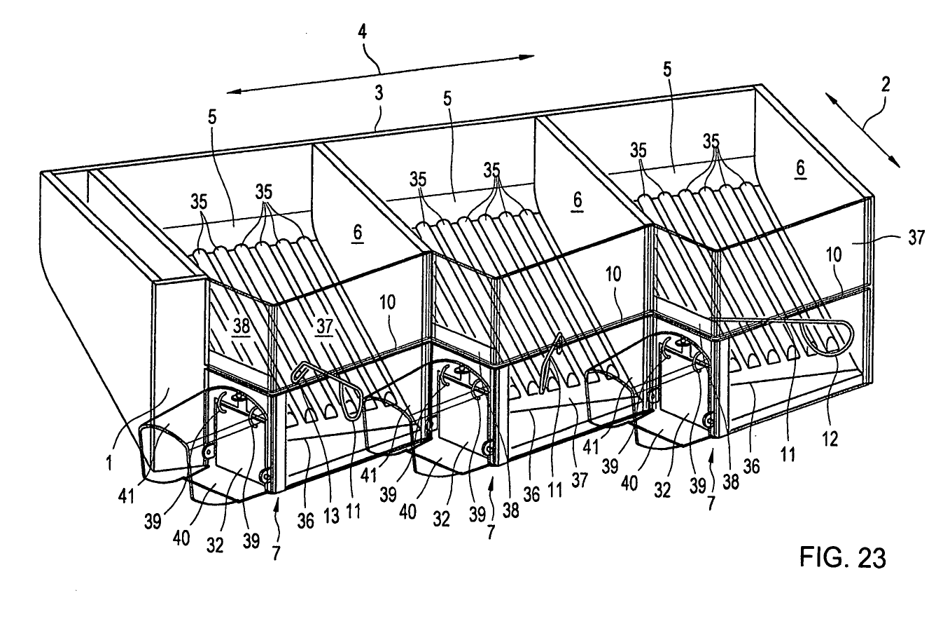

In the third illustrative embodiment described in FIG. 23, the component parts that are identical with those in the first and the second illustrative embodiments are provided with identical reference designations. The first priority is then to deal with the differences from the previously described embodiments. Unless indicated to the contrary, the embodiment in accordance with FIG. 23 is identical with both of the previously described embodiments. Specific attention should be drawn at this point to the fact that mutually mixed forms of the embodiments are conceivable.

The storage areas 5 are provided on the insides of their floor surfaces 18 with a large number of sliding rails 35 running parallel with one another. The sliding rails 35 extend in the longitudinal sense 2 in each case. Since the floor surfaces 18 are inclined downwards at an angle from the rear side 3 in the longitudinal sense 2 in the direction of the front side 1, the sliding rails 35 act like the runners of a sled for the product 19. The product 19 slides easily and accurately into the removal area 7 in this way.

In the illustrative embodiment in accordance with FIG. 23, the receiving area 7 projects from the front side 1, when viewed from above, in the form of a right-angled triangle. A front end line 36 running in the transverse direction 4 parallel to the rear wall of the storage area 5 in this case forms the hypotenuse of the right-angled triangle viewed from above. The actual front side 1 is divided in two into a viewing wall 37 forming a long leg of the right-angled triangle and a removal wall 38 forming a short leg of the right-angled triangle. The transverse slot 10 for the manipulator 11 is built into the transparent viewing wall 37. The manipulator 11, as in the case of the other illustrative embodiments, in turn exhibits the gripping eye 12 and the paddle blade 13. The gripping eye 12 may be executed advantageously as an ergonomically configured handle, so that the handle fits comfortably and positively in the hand of the operator.

Through the previously described configuration of the viewing wall 37 and the removal wall 38, the area of the configuration that is positioned in front of the storage area 5 on the other side of the front line 36 in the longitudinal direction 2 is executed with a triangular shape similar to the right-angled triangle formed by the front end line 36 as its hypotenuse and the viewing wall 37 and the removal wall 38 as its legs. The removal wall 38 in turn has the barrier plate 32 for closing off a removal opening. The barrier plate 32 is mounted on the removal wall 38 in such a way as to be capable of swiveling. In the illustrative embodiment, the barrier plate 32 is executed as a Plexiglas sheet, which is suspended on two annular suspension devices 39. The suspension devices 39 can simply be in the form of key rings, for example. In order to improve the barrier effect produced by the barrier plates 32, it is also conceivable to arrange a plurality of barrier plates actuated, as it were, in series one after the other. Because the customer only has two hands available, the customer is in fact able in each case to open one barrier plate with one hand. He/she does not possess a further hand in this case with which to put a product back 19 once it has been removed.

Positioned in front of the barrier plate 32 in the illustrative embodiment is a guide tray 40. The product 19 that is displaced by the manipulator 11 through the barrier plate 32 slides over the guide tray 40 and out of the configuration into a container disposed beneath the guide tray 40. This can be a receiving basket or a receiving bowl. It is also conceivable to introduce a self-opening bag onto a front part 41 of the removal configuration executed as a removal funnel. The front part 41 is executed for this purpose so that it covers all sides of the removal opening, similarly to the removal chute 26 in the illustrative embodiment in accordance with FIG. 14 to FIG. 22, so that the product 19 to be removed is only able to drop out downwards in the area of the guide tray 40. In a further embodiment, it is conceivable to dispense with the front wall of the front part 41 lying in alignment with the barrier plate 32. In this embodiment, only the upper side and the two side walls of the removal opening that is obstructed by the barrier plate 32 are covered. The front side and the under side are left open, on the other hand, in order to be able to introduce the product 19 to be removed into a bag that has been pulled onto the front part 41. Finally, it should be mentioned that the front part 41 in the illustrative embodiment in accordance with FIG. 23 is executed in the form of a cone in such a way that it broadens out in the direction of the removal wall 38 to permit the spreading of the opening of a bag as it is pushed over the front part 41 in order to receive the product 19 in each case.

The advantage of the embodiment in accordance with FIG. 23 is that the product 19 to be removed is initially brought into the triangular removal area 7, from where it is intentionally passed through the barrier plate 32, in order finally to be removed from the configuration. This embodiment is particularly suitable for long and narrow individual products, for example a loaf of bread.

For the better screening of the products 19 stored in the storage area 5, it is even possible to arrange a plurality of partitions running in the transverse direction 4. Particularly advantageous is the configuration of a partition running in a transverse direction 4 in the area of the front end line 36. The partition exhibits gaps of such a size that only one product 19 at a time that is intended for removal can be brought into the removal area 7.

Finally, specific mention should be made at this point of the fact that a swiveling flap 8 in accordance with the illustrative embodiment represented in FIG. 1 to FIG. 13 can also be provided in the removal area. The same applies to a removal chute similar to the illustrative embodiment represented in FIGS. 14 to 22. The constructive details of the individual illustrative embodiments are accordingly mutually interchangeable in their entirety.

Reference may be made, finally, to a particular embodiment of the removal bags used for the removal of the products 19. It is conceivable here to configure a bag in such a way that two loops project from the edge of the bag. These loops are arranged opposite one another in such a way that the bag can be opened by holding one of the loops in each case. It is thus very easy to produce the mutually opposing loops by stamping at the time of cutting the bag to shape, because the loops lie one above the other in the stamping operation. In order to make the bags available to the customer, they are secured in a dispensing configuration in each case by one loop. The other loop in each case serves as a pulling loop. By pulling on the pulling loop, each bag can be removed from the dispensing configuration. The bag is then opened by pulling on the two loops, and it is pulled over the removal chute 26 or the front part 41.

This application claims the priority, under 35 U.S.C. § 119, of German patent application No. 10 2004 059 568.2, filed Dec. 9, 2004, and of German patent application No. 10 2005 004 466.2, filed Jan. 31, 2005; the entire disclosure of the prior applications are herewith incorporated by reference.

I Claim:

1. A configuration for a removal, piece by piece, of stored products, the configuration comprising:
an outwardly totally closed storage area;
a removal area accessible from outside;
a passage connecting said storage area to said removal area; and
a manipulator for bringing individual products from said storage area through said passage and into said removal area.

2. The configuration according to claim 1, further comprising a swiveling flap functioning as an access device providing access to said removal area.

3. The configuration according to claim 2, wherein said swiveling flap has an inner surface facing towards said removal area and at a same time functions as a supporting surface for a product to be removed.

4. The configuration according to claim 2,
wherein said removal area is a removal compartment, said removal area being closed of by said swiveling flap; and
further comprising a partition wall separating said removal compartment from said storage area, said partition wall having a perforated through opening formed therein forming said passage.

5. The configuration according to claim 4, further comprising a partition kinematically connected to said swiveling flap for ensuring at least a partial closure of said perforated through opening when said swiveling flap is opened.

6. The configuration according to claim 5, further comprising a guide attached to said swiveling flap and facing approximately at right angles from said swiveling flap, said partition is mounted on said guide attached to said swiveling flap.

7. The configuration according to claim 6, wherein said guide functions as an arrester for said swiveling flap in an open position of said swiveling flap.

8. The configuration according to claim 3, further comprising:
a cover plate extending at right angles to a surface of said swiveling flap, said cover plate having a covering surface facing towards an inner surface of said swiveling flap and closes said removal compartment when said swiveling flap is open, said cover plate further having a holding surface facing towards said covering surface; and
a partition attached to said holding surface.

9. The configuration according to claim 1, further comprising a partition wall disposed between said storage area and said removal area, said partition wall having a through opening formed therein and functioning as said passage, said removal area being open towards a bottom such that the products removed from said storage area are caused under an effect of gravity to drop down out of said removal area.

10. The configuration according to claim 9, further comprising an attachment element disposed on said removal area for a receiving container for receiving removed products.

11. The configuration according to claim 9, wherein said removal area is a removal compartment with a removal chute facing downwards as a discharge device for removing the products.

12. The configuration according to claim 9, further comprising a swiveling barrier plate functioning as a device disposed inside said removal area for preventing reaching in.

13. The configuration according to claim 12, further comprising a spring element having a spring pressure, said barrier plate being caused to swivel against the spring pressure of said spring element to provide automatic closure after removing a product.

14. The configuration according to claim 1, wherein said removal area has two mutually opposing passages including said passage.

15. The configuration according to claim 14, wherein said storage area is one of two mutually separate storage areas, and in each case one of said passages connects said removal area to one of said two mutually separate storage areas.

16. The configuration according to claim 1, wherein said manipulator is a paddle having a gripping eye disposed outside said storage area, a paddle bar penetrating a front side of the configuration, and a paddle blade projecting into said storage area.

17. The configuration according to claim 16, wherein said front side has a transverse slot formed therein functioning as a guide rail for said paddle bar penetrating said front side.

18. The configuration according to claim 17, wherein said transverse slot penetrates said front side only in said storage area.

19. The configuration according to claim 17, wherein said transverse slot penetrates said front side both in said storage area and in said removal area.

20. The configuration according to claim 1, wherein said storage area has a floor surface inclined downwards towards a front side of the configuration.

21. The configuration according to claim 1, wherein said storage area has a rear side facing away from said front side and is capable of being folded up as a refilling opening for said storage area.

22. The configuration according to claim 1, wherein said storage area has a floor surface capable of being pulled open to a front and being in a form of a drawer for a purpose of refilling said storage area.

23. The configuration according to claim 2, further comprising a spring element having a spring pressure, said swiveling flap being caused to swivel against the spring pressure of said spring element to provide automatic closure after removing a product.
